(19) United States
(12) Patent Application Publication
(10) Pub. No.: US 2007/0260398 A1
(43) Pub. Date: Nov. 8, 2007

(54) Portable navigation device with accelerometer

(76) Inventor: David Stelpstra, Amsterdam (NL)

Correspondence Address: Jacob Eisenberg;c/o TomTom, Rembrandtplein 35, Amsterdam, 1017 CT, NL

(21) Appl. No.: 11/713,792

(22) Filed: Mar. 5, 2007

(30) Foreign Application Priority Data
Mar. 8, 2006 (GB) 0604709.6
Mar. 8, 2006 (GB) 0604708.8
Mar. 8, 2006 (GB) 0604704.7
Mar. 8, 2006 (GB) 0604706.2

(51) Int. Cl. G01C 21/00

(52) U.S. Cl. 701/213

(57) ABSTRACT

A portable navigation device comprises an accelerometer, a GPS receiver, and a calibration module. The calibration module generates calibration parameters that enable acceleration data from the accelerometer to be accurately converted into speed and heading data and integrated over time to give distance data. The calibration parameters are calculated from GPS derived speed and heading data and resolve or otherwise compensate for (i) the attitude of the portable device with respect to the horizontal plane (“pitch”) and (ii) the angle between the forward direction of the device and the driving direction of a vehicle the device is mounted in (“yaw”).

### BACKGROUND OF THE INVENTION

1. Field of the Invention

This invention relates to a portable navigation device comprising an accelerometer, a GPS receiver, and a calibration module. The calibration module generates calibration parameters that enable acceleration data from the accelerometer to be accurately converted into speed and heading data and integrated over time to give distance data. The term GPS refers to the GPS satellite navigation system, and any equivalent or similar system, such as Galileo.

2. Description of the Prior Art

It is well known to integrate GPS with dead reckoning systems and for the GPS to be used to calibrate the output from the dead reckoning sensors. Reference may be made to “Integration of GPS and Dead-Reckoning Navigation Systems” by Wei-Wen Kao, Vehicle Navigation & Information Systems Conference Proceedings P-253 ISBN 1-56091-191-3. The basic approach there is to use the absolute position accuracy of GPS to provide feedback signals to correct the dead-reckoning errors, while the smoothness and constant availability of the dead-reckoning signals are used to correct GPS position errors (e.g. due to multipath propagation and the selective availability that was imposed at the time the paper was written, 1991). Later systems were designed to correct for the inclination (‘pitch’) and tilt (‘roll’) in embedded or built in automotive systems; reference may be made to EP 1096230, which is also helpful in providing a detailed background. The contents of this publication are incorporated by reference.

However, most current generation automotive navigation devices are not embedded systems at all, but instead portable systems. These pose significant challenges because they are typically removably mounted on suction mounts against the vehicle windshield. These devices are therefore rarely fixed with the same orientation (i.e. pitch, roll or yaw) and in fact any of these factors can alter even during a drive.

### SUMMARY OF THE INVENTION

The invention is a portable navigation device comprising an accelerometer, a GPS receiver, and a calibration module. The calibration module generates calibration parameters that enable acceleration data from the accelerometer to be accurately converted into speed and heading data, in which the calibration parameters are calculated from GPS derived speed and heading data and resolve or otherwise compensate for (i) the attitude of the portable device with respect to the horizontal plane (‘pitch’) and (ii) the angle between the forward direction of the device and the driving direction of a vehicle the device is mounted in (‘yaw’).

The angle between the forward direction of the device and the driving direction of the vehicle the device is mounted in (i.e. ‘yaw’) can be altered at any time by a user of the device and the calibration module will automatically calculate calibration parameters that resolve or otherwise compensate for this changed angle. Modelling yaw is important but prior art systems concentrated on compensating for just pitch and roll, principally because they were focussed on embedded systems. But for portable navigation systems, yaw is a surprisingly important attribute to resolve.

In one implementation, the device calculates calibration parameters for each successive valid GPS-derived speed and heading fix. The device then stores the calculated calibration parameters, and clears any stored calibration parameters that are of more than a predefined age (e.g. 5 seconds old).

Unlike typical prior art system that combine GPS and dead-reckoning systems at the same time, the device may determine its position exclusively using data derived from the accelerometer if the GPS signal is lost and valid calibration parameters are available; when a GPS fix is available, then no assistance from the accelerometer is provided.

In operation, one implementation stores a predefined number of samples of speed and heading calibration parameters together with time and accelerometer data. The device checks that at least n seconds of data is stored and then compares stored GPS and accelerometer data for each n second epoch is compared against thresholds of speed and age.

The portable navigation device can be a touch-screen controlled automotive navigation device. This can be removably mounted onto a vehicle windscreen using a suction mount. It could also be a handheld device, and may also operate as a mobile telephone.

### DETAILED DESCRIPTION

This section describes an Assisted Satellite Navigation (ASN) option for automotive, portable navigation devices. ASN uses a dual axis accelerometer to predict the position when no GPS is available. It may also include an on-board gyrometer for improved accuracy.

To be useful the accelerometer has to be calibrated. The calibration has to be performed to resolve:
The attitude of the device with respect to the horizontal plane
The angle between the forward directions of the device and the driving direction of the car
Biases in the observation due to the physical properties of the accelerometer.
Initial speed and heading values.

The attitude causes part of the acceleration of the earth's gravity field to leak through in the measured accelerations. The angle causes the effect that a single longitudinal or lateral acceleration influences both axes of the accelerometer. If the device is mounted upside down, the lateral axis will be reversed. This situation is set by the user in the preference settings (, and used by the software.

The position used in the device is either a pure GPS solution or a pure ASN solution. These modes are discussed in the next two sections.

2. Behavior if GPS is Available

GPS positions are received typically every second (1 Hz). If GPS positions are available, these are passed unaltered. The speed and heading are passed into the calibration module. This module tries to calculate a set of calibration parameters that is used to convert acceleration into speed and heading. These parameters are recalculated every time a valid GPS fix is received.

The accelerations are tested for reasonable values (sanity check), the values should be less then 20 m/s², i.e. twice the acceleration of the earths gravity. If accepted, they are accumulated and stored. If a GPS fix is received, the age of the last added GPS data is checked. If this age is more than 5 seconds, the calibration is reset. This has the effect that a gap in the GPS data of less than 5 seconds does not invalidate the calibration. In this time span ASN is invoked (if the calibration is valid). If the speed and heading are accepted, they are stored together with its time and the accelerometer data. The last 30 samples are kept, previous ones are discarded. After this a calibration is attempted.

First is a check that at least 30 seconds of data is present. Next, the stored GPS and accelerometer data for each epoch is checked for the following conditions:
The speed should larger than 2.0 m/s,
The age of the data should be less than 30 seconds,
The age of the data should be larger than 0 seconds.

To proceed with the calibration, ¾ of the buffer (30 seconds at 1 Hz is 30 samples) should be available (i.e. 22 samples). A period of 30 seconds of GPS data is needed. The GPS speed and heading are matched against the accelerometer data by a least squares calculation. The observations are weighted based on their age, older observations get less weight. After a first match the data with the largest w-test static are removed, to eliminate outliers. Fifteen percent of the speed and 15% of the heading data is removed. After this a new calibration (without the removed observations) is performed. This results in a set of calibration parameters that is used for ASN when needed.

3. Behavior if GPS is Unavailable

If the GPS receiver looses track of the satellites, no valid GPS position is available. In this situation ASN is used, if the system is calibrated. The calibration parameters together with the accelerations are used to calculate the speed and heading of the vehicle. These are integrated in time to give the ASN derived position. This continues until one of the following conditions is reached:
The calibration parameters are more then 120 seconds old,
The speed is less than 0,
The speed is larger than 170 km/h

The last two conditions may occur due to small error in the calibration parameters. Once there are valid GPS positions again, the calibration is invalidated. The new data will be used to compute a new calibration.

4. Zero Velocity Updates

By looking at the raw accelerometer observations it is possible to detect if the vehicle is stationary. This information is used to update the internal filter and thus used only internally. As of now it is not used in any other functions.

5 Map Matching

To improve the performance of ASN feedback from the map matcher is accepted. The position is map matched in normal fashion. This makes that the position that is shown on the screen stays on the road. Also the heading between two consecutive positions is computed, and the predicted heading is corrected to match the map matched heading.

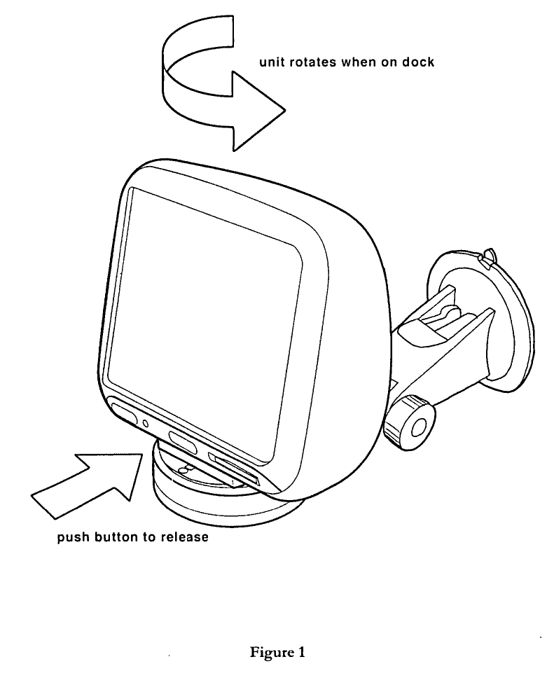

FIG. 1 is a perspective view of an actual implementation of a navigation device and dock. The navigation device is a unit that includes display, internal GPS receiver, microprocessor, power supply and memory systems. The device 1 sits on a docking platform 2; the platform 2 is rotatably mounted an arm 3 that can pivot horizontally about bolt post 4. The arm 3 can also pivot vertically about posts 5, which pass through apertures in a mounting arm which has a large suction cup 6 at one end. As shown in FIG. 1, the device 1 and docking platform 2 can rotate together; this combined with the vertical and horizontal degrees of movement allowed by posts 5 enables the device, when secured to the car dashboard using a large suction cup 43, to be perfectly positioned for a driver. It also means that considerable yaw can be introduced—i.e. the angle between the forward direction of the device and the driving direction of a vehicle the device is mounted in can and will be different most times the device is used, and may even alter during use (for example, the driver might adjust this angle).

System Architecture

In contrast to conventional embedded devices which execute all the OS and application code in place from a large mask ROM or Flash device, an implementation of the present invention uses a new memory architecture. The device, includes conventional items such as a microprocessor, power source, display and related rivers. In addition, it includes a SD card reader; a SD card is shown slotted into position. The device has internal DRAM and XIP Flash.

The device hence uses three different forms of memory:
1. A small amount of internal XIP (eXecute In Place) Flash ROM. This is analogous to the PC's BIOS ROM and will only contain a proprietary boot loader, E² emulation (for UID and manufacturing data) and splash screen bit maps. This is estimated to be 256 KB in size and would be on a slow 8 bit wide SRAM interface.
2. The main system RAM (or DRAM) memory, this is analogous to the PC's main memory (RAM). This will be where all the main code executes from as well as providing the video RAM and workspace for the OS and applications. No persistent user data will be stored in the main system RAM (like a PC) i.e. there will be no “Ram drive”. This RAM will be exclusively connected to a 32 bit 100 MHz synchronous high-speed bus.
3. Non-volatile storage, analogous to the PC's hard disk. This is implemented as removable NAND flash based SD cards. These devices do not support XIP. All the OS, application, settings files and map data will be permanently stored on SD cards

On boot up the proprietary boot loader will prompt for the user to insert the supplied SD card. When this is done, the device will copy a special system file from the SD card into RAM. This file will contain the Operating System and navigation application. Once this is complete control will be passed to the application. The application then starts and access non-volatile data e.g. maps from the SD card.

When the device is subsequently switched off, the RAM contents is preserved so this boot up procedure only occurs the first time the device is used.

Device also includes a GPS receiver with integral antenna.

The following other signals are also connected via the dock to the navigation device:

1. Power from the vehicle

2. A signal to automatically mute the car audio system during a spoken command

3. A signal to switch on and off the device automatically with the vehicles ignition switch or key

4. Audio output signals to play spoken commands on the vehicles audio system.

### APPENDIX 1

GO Product Specification

Introduction

GO is a stand-alone fully integrated personal navigation device that implements the present invention. It will operate independently from any connection to the vehicle.

Target Markets

Go is intended to address the general personal navigation market. In particular it is designed to extend the market for personal navigation beyond the “early adopter” market. As such it is a complete stand-alone solution; it does not require access to a PC, PDA or Internet connection. The emphasis will be on completeness and ease of use.

Although Go is a complete personal navigation solution it is primarily intended for in vehicle use. The primary target market is anybody who drives a vehicle either for business or pleasure.

To successfully address this market Go must satisfy the following top-level requirements:
1. Acceptable price point—Appropriate compromise between product features and cost.
2. Simplicity—Installation and operation of Go will be simple and intuitive, all major functions should be accomplished by an average non PC-literate user without recourse to the product manual.
3. Flexibility—All map data and operating programs will be supplied on plug in memory cards. The device can easily be extended to cover different locals.
4. Reliability—Although in-car navigation systems are not considered safety critical components users will come to rely on Go. It will be engineered to all relevant automotive environmental standards. In addition it will be tolerant to short GPS coverage outages.
   Channels
Consumer electronics retail outlets
Automotive accessory outlets
Specialist car accessory fitting garages
   Product Summary

Go is an in-vehicle personal navigation device. It is designed as an appliance, that is, for a specific function rather than a general purpose one. It is designed for the consumer after-sales automotive market. It will be simple to use and install by the end user, although a professional fitting kit will be optionally supplied.

The principal features are:
Built on standard commodity PocketPC 2002 components
Standard PocketPC 3.5″ ¼ VGA transflective TFT LCD display mounted in landscape orientation
Romless soft-boot memory architecture
Highly integrated ARM9 200 MHz CPU
SD card memory slot for application and map data storage
Integrated GPS receiver and antenna
Integrated two axis accelerometer for simple dead reckoning
Power, audio, debug and external GPS antenna connections made through docking connector on base of unit
Embedded Linux OS with no GUI layer, application provides its own UI
Very simple touch screen UI optimised for finger use
High quality integrated speaker for voice instructions
Internal rechargeable Li-Ion battery giving at least five hours of continuous operation
   Operating System

Go will use a customised version of embedded Linux. This will be loaded from an SD card by a custom boot-loader program which resides in Flash memory

Hard Buttons

Go will have only one hard button, the power button. It is pressed once to turn on or off Go. The UI will be designed so that all other operations are easily accessible through the pen based UI. There will also be a concealed hard reset button.

Architecture

Go architecture is based around a highly integrated single chip processor designed for mobile computing devices. This device delivers approximately 200 MIPs of performance from an industry standard ARM920T processor. It also contains all the peripherals required excluding the GPS base-band. These peripherals include DRAM controller, timer/counters, UARTs, SD interface and LCD controller.

The main elements of this architecture are:
Microprocessor running at 200 MHz
32 MB or 64 MB of fast synchronous DRAM (SDRAM) with low power self refresh. Arranged as two devices on a 32 bit wide 100 MHz bus
SD card interface for all non-volatile storage including the OS (No RAM drive)
Native (bare metal) boot loader stored in 256 KB of NOR Flash. This Flash device will contain a boot sector which is write protected to store protected data such as unique product ID's and manufacturing data.
Debug UART (RS232 3V levels) connected to the docking connector
USB client for PC connectivity
Integrated GPS receiver
Integrated two axis accelerometer
Optional integrated Bluetooth transceiver for PDA and mobile phone connectivity
High quality audio through I²S codec and amplifier

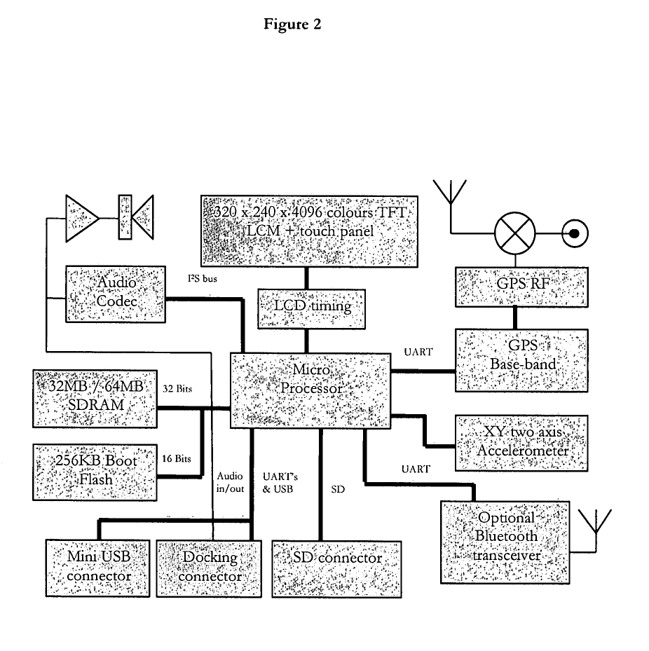

The Go block diagram is at FIG. 2.

Power Management

Go will be powered from an integrated Li-Ion 2200 mAH rechargeable battery. This battery can be charged, and the device powered (even if the battery contains no charge) from an externally supplied +5V power source. This external +5V power source is supplied via the docking connector or a DC jack socket.

This +5V supply will be generated from the vehicle's main supply rail or from a mains adapter externally. The device will be turned on and off by a single button. When the device is turned off the DRAM contents will be preserved by placing the RAM in self-refresh so that when switched on Go will resume from where it was switched off. There will also be a wake-up signal available through he docking connector, this can be used to auto-switch on Go when the vehicle ignition is switched on.

There will also be a small hidden reset switch.

System Memory Architecture

In contrast to conventional embedded devices which execute all the OS and application code in place from a large mask ROM or Flash device, Go will be based on a new memory architecture which is much closer to a PC.

This will be made up of three forms of memory:
4. A small amount of XIP (eXecute In Place) Flash ROM. This is analogous to the PC's BIOS ROM and will only contain a proprietary boot loader, E² emulation (for UID and manufacturing data) and splash screen bit maps. This is estimated to be 256 KB in size and would be on a slow 8 bit wide SRAM interface.
5. The main system memory, this is analogous to the PC's main memory (RAM). This will be where all the main code executes from as well as providing the video RAM and workspace for the OS and applications. Note: No persistent user data will be stored in the main system RAM (like a PC) i.e. there will be no “Ram drive”. This RAM will be exclusively connected to a 32 bit 100 MHz synchronous high-speed bus. Go will contain two sites for 16 bit wide 256/512 Mbit SDRAM's allowing memory configurations of 32 MB (16 bit wide) 64 MB 32 bit wide and 128 MB (32 bit wide).
6. Non-volatile storage, analogous to the PC's hard disk. This is implemented as removable NAND flash based SD cards. These devices do not support XIP. All the OS, application, settings files and map data will be permanently stored on SD cards
   Audio

A 52 mm diameter speaker is housed in Go to give good quality spoken instructions. This will be driven by an internal amplifier and audio codec. Audio line out will also be present on the docking connector.

SD Memory Slot

Go will contain one standard SD card socket. These are used to load system software and to access map data.

Display

Go will use a transflective 3.5″ TFT backlit display It will be a ‘standard’ ¼ VGA display as used by PocketPC PDA's. It will also contain a touch panel and bright CCFL backlight.

Power Supplies

Power Supply—AC adapter socket

4.75V to 5.25V (5.00V+/−5%) @ 2A

Power Supply—Docking Connector

4.75V to 5.25V (5.00V+/−5%) @ 2A

Variants

It shall be possible to assemble and test the following variants of Go:

Standard (Bluetooth depopulated, 32 Mbyte RAM)

In the Standard variant the Bluetooth function is not populated, and 32 Mbytes RAM is fitted.

Bluetooth Option (Future Variant)

The product design should include Bluetooth although it is not populated in the standard variant to minimise BOM cost. The design should ensure that all other functions (including GPS RF performance) operate without degradation when the Bluetooth function is operating.

64 Mbyte RAM Option (Future Variant)

The product design should ensure it is possible to fit 64 Mbyte RAM instead of 32 Mbyte.

Subassemblies

Go consists of various electrical subassemblies.

RF Cable

The RF cable feeds the RF signal from an external GPS antenna (which connects to Go via the RF docking connector) to the RF PCB where the GPS module is situated.

External Connectors

Docking Connectors

Two Docking Connectors provide an interface to external Docking Stations.

Docking Connector #1 pinout

| Pin | Signal | Dir | Type | Description |
|---|---|---|---|---|
| 1 | GND | — | — | Signal and power GND |
| 2 | GND | — | — | |
| 3 | DOCKSNS1 | I/P | PU | Docking Station Sense [0, 1] - |
| 4 | DOCKSNS0 | I/P | PU | These signals are connected to |
| | | | | pull-up resistors within the unit. |
| | | | | The Docking Station pulls either |
| | | | | or both of these signals to GND |
| | | | | to indicate the presence and type |
| | | | | of Docking Station. |
| 5 | AUDIOL | O/P | | Audio line outputs (Left and Right) |
| 6 | AUDIOR | O/P | | to connect to car audio system. |
| 7 | MUTE | O/P | O/D | The unit pulls this line to GND to |
| | | | | signal the car audio system to |
| | | | | mute itself while the unit is |
| | | | | issuing a voice command. |
| 8 | IGNITION | I/P | PD | Ignition sense. |
| 9 | DOCKPWR | I/P | PWR | +5 V power from the Docking |
| 10 | DOCKPWR | I/P | PWR | Station to simultaneously power the |
| | | | | unit and charge the battery. |

PWR Power connection
PU Pull-Up resistor within the unit
O/D Open-Drain output
PD Pull-Down resistor within the unit

Docking Connector #2 pinout

| Pin | Signal | Dir | Type | Description |
|---|---|---|---|---|
| 1 | TXD | O/P | UART | 3 V logic level UART signals |
| 2 | RXD | I/P | UART | |
| 3 | RTS | O/P | UART | |
| 4 | CTS | I/P | UART | |
| 5 | GND | — | PWR | |
| 6 | nTRST | I/P | JTAG | CPU JTAG signals for test |
| 7 | TMS | I/P | JTAG | and configuration |
| 8 | TCK | I/P | JTAG | |
| 9 | TDI | I/P | JTAG | |
| 10 | TDO | O/P | JTAG | |

RF Docking Connector

The RF Docking Connector allows connection of an external active GPS antenna via a Docking Station.

AC Adapter Socket

The AC adapter socket allows power to be supplied from a low cost AC adapter or CLA (Cigarette Lighter Adapter).

USB Connector

The USB connector allows connection to a PC by means of a standard mini USB cable.

SD Card Socket

A hard locking SD card socket suitable for high vibration applications supports SDIO, SD memory and MMC cards.

(Although Go provides hardware support for SDIO, software support will not be available at the time of product introduction)

Processor

The processor is the ARM920T based SOC (System on chip) operating at approx 200 Mhz.

RAM

Go will be fitted with RAM to the following specification:

| | |
|---|---|
| Type | SDRAM with low-power refresh (“mobile” SDRAM) |
| Total memory | 32 Mbyte (standard) or 64 Mbyte (future option) |
| Bus width | 32-bit |
| Minimum speed | 100 Mhz |
| Maximum self | 500 μA per device |
| refresh current | |
| Configuration | 2 × 16-bit wide CSP sites |

Flash Memory

Go will be fitted with a minimum of 256 kbyte of 16-bit wide Flash Memory to contain the following:
Boot loader code to enable loading of O/S from SD card
Factory set read-only protected manufacturing parameters (e.g. manufactured date) and unique ID (E2PROM emulation)
User specific settings (E2PROM emulation)

The following devices can be used depending on price and availability.:

GPS Internal Antenna

The GPS internal antenna is attached directly to the RF PCB.

GPS External (Active) Antenna Switching

When an external antenna is connected via the RF Docking Connector, the GPS antenna source is automatically switched to the external antenna.

Accelerometer

A solid state accelerometer is connected directly to the processor to provide information about change of speed and direction.

Auxiliary Functions

Ignition Synchronization

Ignition Wakeup

A rising edge on the Docking Station IGNITION signal will wakeup the unit. The IGNITION signal may be connected to a 12V or 24V vehicle battery.

Ignition State Monitoring

The state of the Docking Station IGNITION signal is detected and fed to a GPIO pin to allow software to turn off the unit when the ignition signal goes low.

Standard Peripherals

The following peripherals will be included as standard with Go.
Simple docking shoe. Mounts Go and allows charging through a DC jack. No other connectivity is included in the simple dock.
Cigarette lighter power cable connecting to Go through the DC jack socket or simple docking shoe.
Mini USB cable for PC connectivity
Universal mains adapter for connection to DC Jack socket
   Optional Peripherals

The following optional peripherals will be available at or after the time of launch of Go
Active antenna kit. Contains a GPS active antenna and a docking shoe with GPS RF connector and cable fitted. For self installation when an external antenna is required.
Professional vehicle docking kit. For fitting by professional installation only. Allows direct connection to vehicle supply, audio system and active antenna via a vehicle interface box.

1. A portable navigation device comprising an accelerometer, a GPS receiver, and a calibration module, the calibration module generating calibration parameters that enable acceleration data from the accelerometer to be accurately converted into speed and heading data, in which the calibration parameters are calculated from GPS derived speed and heading data and resolve or otherwise compensate for (i) the attitude of the portable device with respect to the horizontal plane and (ii) the angle between the forward direction of the device and the driving direction of a vehicle the device is mounted in.

2. The portable navigation device of claim 1 in which the calibration parameters resolve or otherwise compensate for biases in observation due to the physical properties of the accelerometer.

3. The portable navigation device of claim 1 in which the calibration parameters resolve or otherwise compensate for initial speed and heading values.

4. The portable navigation device of claim 1 in which the angle between the forward direction of the device and the driving direction of the vehicle the device is mounted in can be altered at any time by a user of the device and the calibration module will automatically calculate calibration parameters that resolve or otherwise compensate for this changed angle.

5. The portable navigation device of claim 1 in which the device calculates calibration parameters for each successive valid GPS-derived speed and heading fix.

6. The portable navigation device of claim 5 in which the device stores the calculated calibration parameters, and clears any stored calibration parameters that are of more than a predefined age.

7. The portable navigation device of claim 6 in which the predefined age is 5 seconds.

8. The portable navigation device of claim 1 in which the device determines its position exclusively using data derived from the accelerometer if the GPS signal is lost and valid calibration parameters are available.

9. The portable navigation device of claim 1 in which the device stores a predefined number of samples of speed and heading calibration parameters together with time and accelerometer data.

10. The portable navigation device of claim 9 in which the device checks that at least n seconds of data is stored and then compares stored GPS and accelerometer data for each n second epoch is compared against thresholds of speed and age.

11. The portable navigation device of claim 10 in which the thresholds are:
The speed is larger than 2.0 m/s,
The age of the data is less than 30 seconds,
The age of the data is larger than 0 seconds.

12. The portable navigation device of claim 1 in which to proceed with a calibration, the GPS speed and heading are matched against the accelerometer data by a least squares calculation.

13. The portable navigation device of claim 12 in which observations are weighted based on their age, with older observations getting less weight.

14. The portable navigation device of claim 13 in which after a first match, the data with the largest w-test static is removed, to eliminate outliers.

15. The portable navigation device of claim 12 in which a predefined percentage of the heading data is removed and then a new calibration (without the removed observations) is performed to results in a set of calibration parameters that is used for non-GPS based navigation when needed.

16. The portable navigation device of claim 1 in which the accelerometer is a 2-axis accelerometer.

17. The portable navigation device of claim 1 in which the device is a touch-screen controlled automotive navigation device.

18. The portable navigation device of claim 17 in which the device is removably mounted onto a vehicle windscreen using a suction mount.

19. The portable navigation device of claim 1 in which the device is a handheld device.

20. The portable navigation device of claim 1 in which the device is a mobile telephone.
